(19) United States
(12) Patent Application Publication
(10) Pub. No.: US 2024/0268343 A1
(43) Pub. Date: Aug. 15, 2024

(54) SHOWER FILTER ASSEMBLY FOR ATTRACTING PET TO BATHING

(71) Applicant: Arofeel US LLC, Dover, DE (US)

(72) Inventor: JANG PIL BAE, Seoul (KR)

(21) Appl. No.: 18/109,671

(22) Filed: Feb. 14, 2023

(51) Int. Cl. A01K 13/00; C02F 1/68

(52) U.S. Cl. CPC A01K 13/001; C02F 1/688; C02F 2307/06

(57) ABSTRACT

A shower filter assembly for calming and attracting a dog to bathing includes a housing and a filter cartridge. The housing includes an upper case and a lower case to form a filter chamber, and the housing is constructed to be installed between a shower head and a water conduit. The filter cartridge includes a filter and a filter frame, and the filter frame is constructed to retain the filter therein. The lower case has an inlet and the upper case has an outlet such that water flows from the water conduit to the filter chamber through the inlet and flows out of the filter chamber to the shower head through the outlet. The filter is comprised of aromatic oil, dextrin, guar gum, vitamin C, and water. The filter is water-soluble and made in gel-type solid.

### FIELD OF THE INVENTION

The present invention relates to a shower filter assembly for attracting a pet to bathing, and more particularly, a shower filter assembly for calming and attracting a pet to bathing, which include a housing, constructed to be installed between a shower head and a hose, and a filter cartridge, equipped with a filter and constructed to be inserted in the housing. The filter is made in gel-type solid and water-soluble, containing a pet-attracting ingredient, vitamin C and/or aromatic oil.

### BACKGROUND OF THE INVENTION

Pets such as dogs, cats, or the likes need to get clean or bathed in order to be hygienic and avoid skin and health issues like bacteria, fungal infections, etc. They need to be bathed if they roll in mud puddles or the like. However, bathing a pet like a dog or cat is generally very hard, and many pets hate water and shudder even at the sound of a faucet turning on. Something, it may require two people to bathe a pet where one holds the pet while the other gives him a bath.

In order to address this problem, various pet washing techniques and tips have been introduced such as pet training method for a pet bathing, pet bathing techniques, or toys to attract a pet to bathing. However, such training method or techniques are hard to learn and pets are not easy to train for bathing. In addition, such toys are not effective in attracting a pet to bathing.

Therefore, to solve the above problems, a shower filter assembly for calming and attracting a pet to bathing is provided to help a pet like bathing, as there is a need for such a device and a method that accomplish this goal.

This invention is directed to solve these problems and satisfy the long-felt need.

### SUMMARY OF THE INVENTION

The present invention contrives to solve the disadvantages of the prior art. The present invention provides a shower filter assembly for calming and attracting a pet to bathing.

The object of the present invention is to provide a shower filter assembly for calming and attracting a dog to bathing includes a housing and a filter cartridge. The housing includes an upper case and a lower case to form a filter chamber, and the housing is constructed to be installed between a shower head and a water conduit. The filter cartridge includes a filter and a filter frame, and the filter frame is constructed to retain the filter therein. The lower case has an inlet and the upper case has an outlet such that water flows from the water conduit to the filter chamber through the inlet and flows out of the filter chamber to the shower head through the outlet.

Side of the filter frame is made of a plurality of vertical ribs. Top of the filter frame is made of radially extending ribs, which are respectively connected to the plurality of vertical ribs, and a circular rib, which are connected to the radially extending ribs. In addition, bottom of the filter frame is made of a circular rib, which is connected to the plurality of vertical ribs, and the bottom of the filter frame is open.

The shower filter assembly further includes a screen frame, which is constructed to be retained right below the outlet by a friction fit between the upper case and the screen frame. The screen frame is made by radially extending ribs and a circumferential circular rib such that water passes through the screen frame in between the radially extending ribs of the screen frame and then to the shower head through the outlet.

The bottom of the screen frame is convex in order to provide room for water to flow in between the convex bottom of the screen frame and the flat top of the filter frame and preventing the water passage from being blocked by the filter frame and/or the filter.

The filter is manufactured in gel-type solid and water-soluble. The filter contains aromatic oil which emits dog urine odors. Dog urine odors or smells excite and attract dogs to bathing. Furthermore, the filter frame is constructed to allow the filter to be dissolved in the running water.

The filter further contains dextrin and guar gum. Dextrin is water soluble and porous and can include aromatic oil in its pores so that aromatic oil can be effectively dispersed into the air from water, thus spreading dog urine smells to attract dogs to bathing. Guar gum is obtained from the seeds of the guar plant called Cyamopsis tetragonolobus and solidifies the mixture aromatic oil, dextrin, guar gum, and water into a water-soluble gel-type solid which can be filled in the filter frame. The mixture may further include vitamin C which is an antioxidant for pets including dogs and helps reduce potentially harmful free radicals in pets' body and reduce inflammation and cognitive aging.

Another object of the present invention is to provide a shower filter assembly for being used to bathe a pet includes a housing and a filter cartridge. The housing includes an upper case and a lower case to form a filter chamber, and the housing is constructed to be installed between a shower head and a water conduit. The filter cartridge includes a filter and a filter frame, and the filter frame is constructed to retain the filter therein. The shower filter assembly further includes a screen frame, which is constructed to be retained right below the outlet by a friction fit between the upper case and the screen frame.

Still another object of the present invention is to provide a method for manufacturing a shower gel filter cartridge for attracting a dog to bathing, includes the steps of: mixing aromatic oil, dextrin, and guar gum for making a mixture; aging the mixture at about 10˜15° C. (first aging); adding water to the mixture and kneading the mixture for making the mixture doughy; and aging the mixture second time at about 10˜15° C. (second aging). After the step of mixing aromatic oil, dextrin, and guar gum, the mixture is made in the form of powder, and this step may further include adding vitamin C to make the mixture. Preferably, the step of first aging is for about 24 hours, and the step of second aging is for about 24 hours. In a preferred embodiment, the mixture is comprised of about 2-3 weight percentage of aromatic oil, about 30 weight percentage of dextrin, about 3-5 weight percentage of guar gum, about 60 weight percentage of vitamin C, and about 2-5 weight percentage of water, totaling 100%. The method may further include the step of filling the mixture into a filter frame 60 to make to the filter cartridge.

Aromatic oil emits dog urine odors to excite and attract dogs to bathing. Dextrin is water soluble and porous and can retain aromatic oil in its pores so that aromatic oil can be effectively dispersed into the air from water, thus spreading dog urine smells to attract dogs to bathing. Guar gum solidifies the mixture of aromatic oil, dextrin, guar gum, and water into a water-soluble gel-type solid which can be filled in the filter frame. The mixture may further include vitamin C which is an antioxidant for pets including dogs and helps reduce potentially harmful free radicals in pets' body and reduce inflammation and cognitive aging.

The advantages of the present invention are: (1) the shower filter assembly of the present invention provides the structure to house the filter cartridge in its filter chamber in order for the filter to be effectively and gradually dissolved in the running water to the shower head during the intended period of time; (2) the filter of the present invention includes aromatic oil which emits dog urine odors to calm and attract dogs to bathing; (3) the filter cartridge is constructed in a rib-structure to allow the filter to be effectively and gradually dissolved in the running water; (4) the filter cartridge includes a sticker to allow two different periods of time for the filter to be completely dissolved in the running water where the filter is completed dissolved in about 3-5 minutes without the sticker attached to the filter frame and about 10-20 minutes with the sticker attached to the filter frame; (5) the shower filter assembly includes a screen frame, which is made of the radially extending ribs, in order to prevent the filter from being broken in a large piece and clogging the outlet of the shower filter assembly; (6) the bottom of the screen frame is concave to provide room between the screen frame and the top of the filter cartridge for water to flow in the room to the outlet; (7) the diameter of the filter chamber is greater than that of the inlet or outlet such that the pressure in the filter chamber is lower for the running water to gradually dissolve the filter; (8) the filter is comprised of aromatic oil to emit dog urine smells, dextrin to retain aromatic oil in its pores, vitamin C to improve the health of a pet, and guar gum to solidify the mixture of aromatic oil, dextrin, guar gum, water, and vitamin C; and (9) the filter is constructed to be completely dissolved in the running water during the intended period of time, and thereafter, there is no dog urine smell, enabling use of the shower head by a person after bathing a pet or dog.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of the shower filter assembly according to the present invention;

FIG. 2 is an exploded view of the shower filter assembly according to the present invention;

FIGS. 3A and 3B are cross-sectional views of the shower filter assembly when water does not flow (FIG. 3A) and does flow (FIG. 3B) according to the present invention;

FIG. 4 is an exploded, cross-sectional view of the shower filter assembly according to the present invention;

FIGS. 5A, 5B, and 5C are respectively a top perspective view, side view, and bottom perspective view of the upper case according to the present invention;

FIGS. 6A, 6B, and 6C are respectively a bottom perspective view, side view, and top perspective view of the screen frame according to the present invention;

FIGS. 7A, 7B, 7C, 7D, and 7E are respectively a top perspective view of the filter cartridge, side view of the filter cartridge, bottom perspective view of the filter cartridge, bottom perspective view of the filter cartridge with the sticker, and top perspective view of the filter frame;

FIGS. 8A, 8B, and 8C are respectively a top perspective view, side view, and bottom perspective view of the lower case according to the present invention; and

FIGS. 9A, 9B, and 9C respectively show a shower head attached to a hose, the shower head separated from the hose, and the shower filter assembly installed in between the shower head and the hose according to the present invention.

### DETAILED DESCRIPTION OF EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment. Additionally, in all of the embodiments detailed below, call forwarding includes call routing.

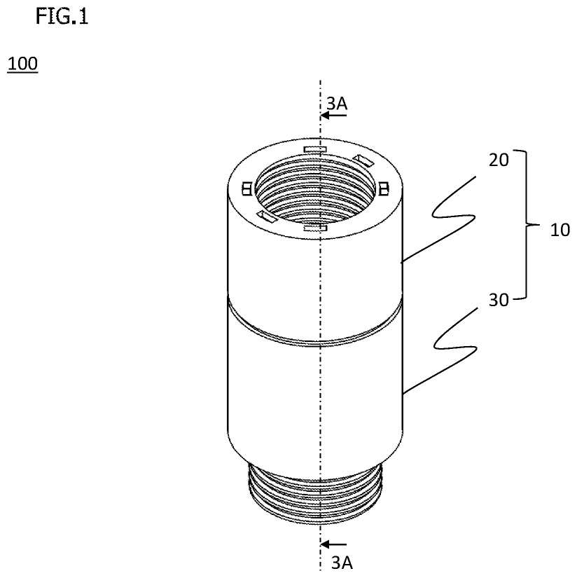

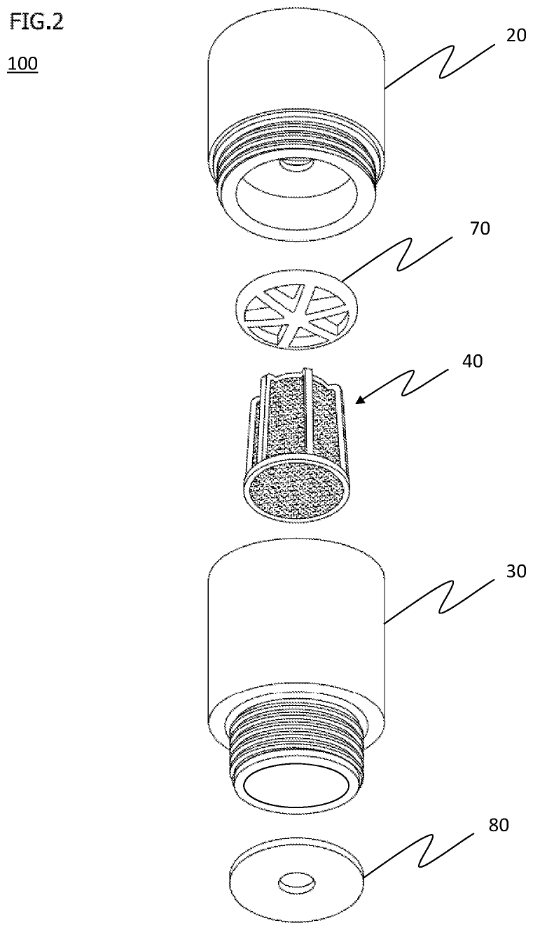

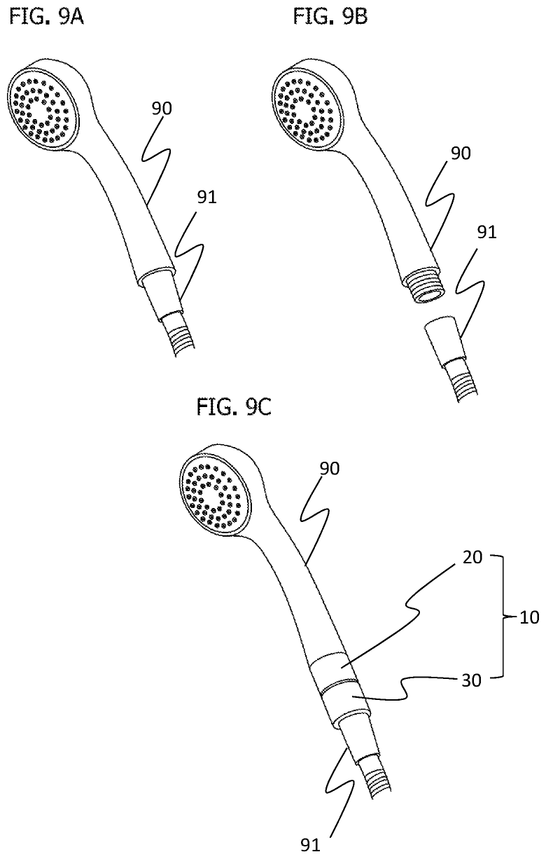

FIGS. 1 and 2 respectively show perspective view and exploded view of the shower filter assembly 100 according to the present invention. FIGS. 9A, 9B, and 9C respectively show a shower head 90 attached to a hose 91, the shower head 90 separated from the hose 91, and the shower filter assembly 100 installed in between the shower head 90 and the hose 91 according to the present invention.

In one embodiment, the shower filter assembly 100 for attracting a dog (not shown) to bathing includes a housing 10 and a filter cartridge 40. The housing 10 includes an upper case 20 and a lower case 30, and the housing 10 is constructed to be installed between a shower head 90 and a water conduit 91. The filter cartridge 40 includes a filter 50 and a filter frame 60, and the filter frame 60 is constructed to retain the filter 50 therein,

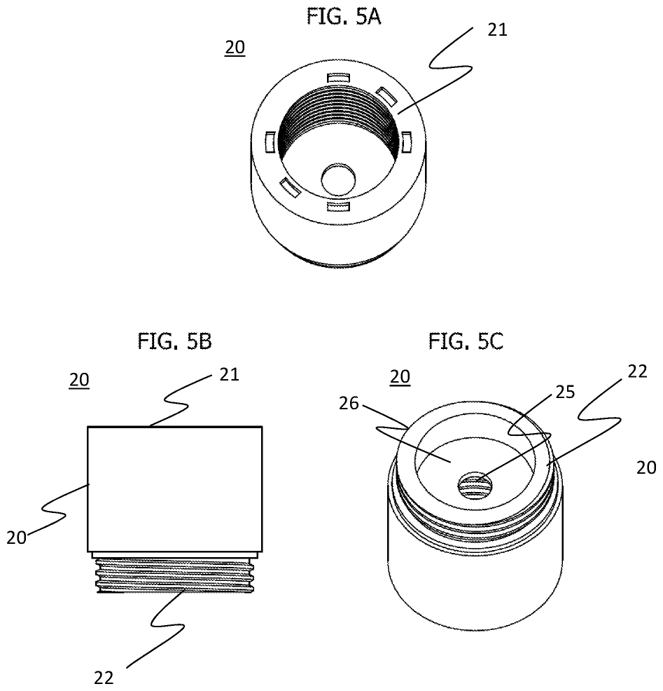

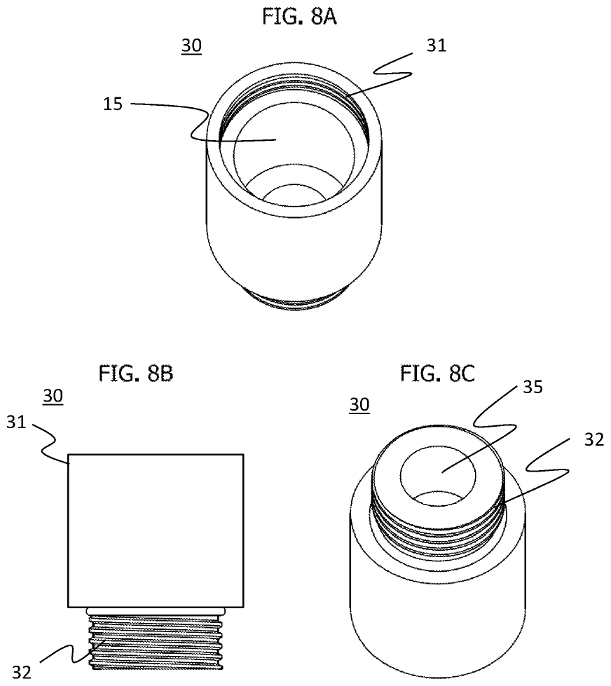

FIGS. 5A, 5B, and 5C respectively show a top perspective view, side view, and bottom perspective view of the upper case 20, and FIGS. 8A, 8B, and 8C respectively show a top perspective view, side view, and bottom perspective view of the lower case 30. As shown in FIGS. 5A, 5B, and 5C, top portion 21 of the upper case 20 is threaded to be coupled to threads of the shower head 90, and bottom portion 32 of the lower case 30 is threaded to be coupled to threads of the water conduit 91. Threads of the shower head 90 are originally coupled to threads of the water conduit 91 as shown in FIG. 9A, but they are separated as shown in FIG. 9B in order for the top portion 21 of the upper case 20 to be coupled to the shower head 90 and for the bottom portion 32 of the lower case 30 to be coupled to the water conduit 91 as shown in FIG. 9C. In addition, bottom portion 22 of the upper case 20 and top portion 31 of the lower case 30 are respectively threaded to be coupled to each other to form a filter chamber 15 for receiving the filter cartridge 40 therein as shown in FIGS. 1, 2, 3A, and 3B. In one embodiment, as shown in FIGS. 2 and 9B, the shower head 90 is exteriorly threaded; the top portion 21 of the upper case 20 is internally threaded; the bottom portion 22 of the upper case 20 is exteriorly threaded; the top portion 31 of the lower case 30 is internally threaded; the bottom portion 32 of the lower case 30 is exteriorly threaded; and the water conduit 91 is internally threaded. In order to prevent water leakage, O-ring is placed into a groove formed right above the threads on the bottom portion 22 of the upper case 20, and another O-ring is placed into a groove formed right above the threads on the bottom portion 32 of the lower case 30. In the alternative embodiment, the shower head 90 is internally threaded; the top portion 21 of the upper case 20 is exteriorly threaded; the bottom portion 22 of the upper case 20 is internally threaded; the top portion 31 of the lower case 30 is exteriorly threaded; the bottom portion 32 of the lower case 30 is internally threaded; and the water conduit 91 is exteriorly threaded.

The lower case 30 has an inlet 35 and the upper case 20 has an outlet 25 such that water flows from the water conduit 91 to the filter chamber 15 through the inlet 35 and flows out of the filter chamber 15 to the shower head 90 through the outlet 25. Preferably, the inlet 35 is formed on the bottom portion 32 of the lower case 30, and the inlet 25 is formed in the form of a hole 25 on a plate 26 which is disposed about between the top portion 21 and bottom portion 22 of the upper case 20 as shown in FIGS. 2, 5A, 5B, and 5C. Alternatively, the plate 26 may be disposed on the bottom portion 22 of the upper case 20.

The filter 50 is manufactured in gel-type solid and water-soluble. The filter 50 contains aromatic oil which emits dog urine odors. Dog urine odors or smells excite and attract dogs to bathing. Furthermore, the filter frame 60 is constructed to allow the filter 50 to be dissolved in the water, more specifically, in the running water.

In a preferred embodiment, the upper case 20, the lower case 30, and the filter chamber 15 are cylindrical, and the filter chamber 15 is cylindrical as well. In addition, the filter frame 60 is cylindrical or truncated-cone-shaped.

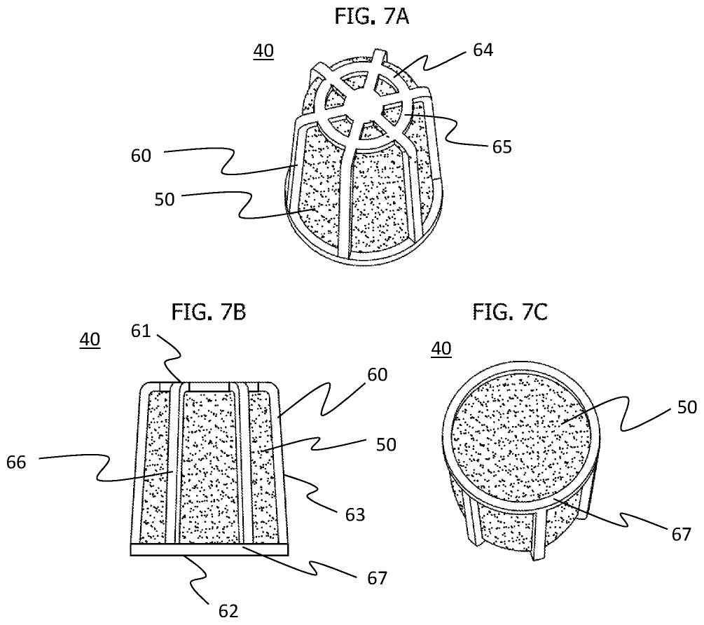

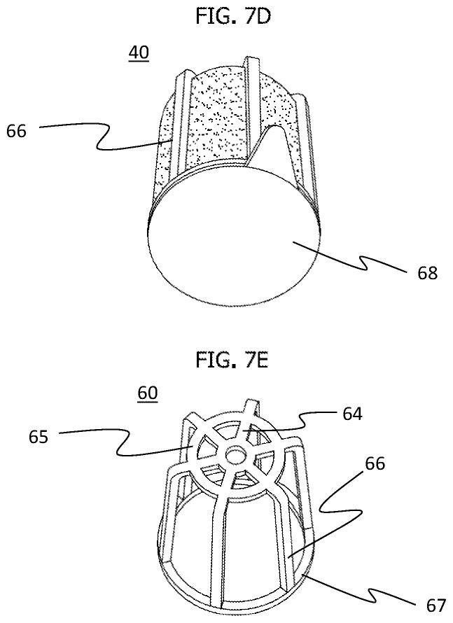

FIGS. 7A, 7B, 7C, 7D, and 7E respectively show a top perspective view of the filter cartridge 40, side view of the filter cartridge 40, bottom perspective view of the filter cartridge 40, bottom perspective view of the filter cartridge 40 with the sticker 68, and top perspective view of the filter frame 60.

As shown in FIG. 7E, side 63 of the filter frame 60 is made of a plurality of vertical ribs 66. Top 61 of the filter frame 60 is made of radially extending ribs 64, which are respectively connected to the plurality of vertical ribs 66, and a circular rib 65, which are connected to the radially extending ribs 64. The diameter of the circular rib 65 is smaller than the length of the radially extending rib 64, and this structure helps the filter 50 being dissolved from its side and the dissolved water being flown upwardly to the shower head 90 through the outlet 25.

Bottom 62 of the filter frame 60 is made of a circular rib 67, which is connected to the plurality of vertical ribs 66, and the bottom 62 of the filter frame 60 is open. The top 61 of the filter frame 60 further includes a circular rib 64 which are connected to the radially extending ribs 64. The diameter of the circular rib 65 of the top of the filter frame 60 is smaller than the length of the radially extending rib 64 and also smaller than the diameter of the circular rib 67 of the bottom of the filter frame 60.

Accordingly, the filter frame 60 is made of various ribs and its bottom, side, and top are open in between the ribs such that the filter 50 can be in contact with water and dissolved. The bottom 62 of the filter frame 60, which is made of the circular rib 67 and open, may be covered by a removable sticker 68. With the removable sticker 68 being attached to the bottom 62 of the filter frame 60, the filter 50 is constructed to be completely dissolved in the running water in about 3-5 minutes. The filter 60 is dissolved from its side and top and gets smaller and smaller until completely dissolved. Without the removable sticker 68, it takes a little longer because the filter 50 is dissolved from the bottom 62 as well, and the filter 50 is constructed to be completely dissolved in the running water in about 10-20 minutes.

In other words, the filter 50 is constructed to be substantially completely dissolved in the running water in about 3-5 minutes when the sticker 68 is removed from the filter 50 and the filter 50 is placed in the filter chamber 15, and the filter 50 is constructed to be substantially completely dissolved in the running water in about 10-20 minutes when the sticker 68 is not removed from the filter 50 and the filter 50 is placed in the filter chamber 15. A user can choose between these two time frames and whether to leave or remove the sticker 68, depending on her needs or way of bathing a pet. In a preferred embodiment, the filter 50 may be made to be about 5 grams and dissolved in up to 20 minutes with the sticker 68 attached at water temperature of 35° C. and water pressure of 3.5-4.0 kg/cm².

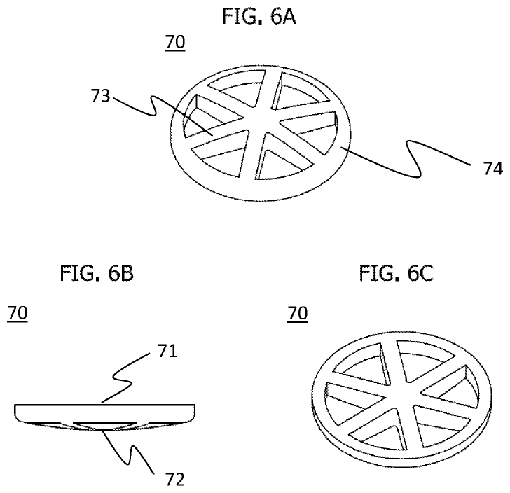

FIGS. 6A, 6B, and 6C respectively show a bottom perspective view, side view, and top perspective view of the screen frame 70 according to the present invention. The shower filter assembly 100 further includes a screen frame 70, which is constructed to be retained right below the outlet 25 by a friction fit between the upper case 20 and the screen frame 70. The screen frame 70 is made by radially extending ribs 73 and a circumferential circular rib 74 such that water passes through the screen frame 70 in between the radially extending ribs 73 of the screen frame 70 and then to the shower head 90 through the outlet 25. Preferably, the outlet 25 is formed in a circle and placed at about the center of the plate 26 such that the outlet 25, the radially extending ribs 73, and the circumferential circular rib 74 are con-centric to allow water pass between the radially extending ribs 73 and through the outlet 25 to the shower head 90. The radially extending ribs 73 divide the water passage and prevent the filter 50 from being broken in a large piece and blocking the outlet 25.

In addition, top 71 of the screen frame 70 is flat and bottom 72 of the screen frame 70 is convex. The top 61 of the filter frame 60 is flat so that the convex bottom 72 of the screen frame 70 is in contact with the flat top 61 of the filter frame 60, providing room for water to flow in between the convex bottom 72 of the screen frame 70 and the flat top 61 of the filter frame 60 and preventing the water passage from being blocked by the filter frame 60 and/or the filter 50.

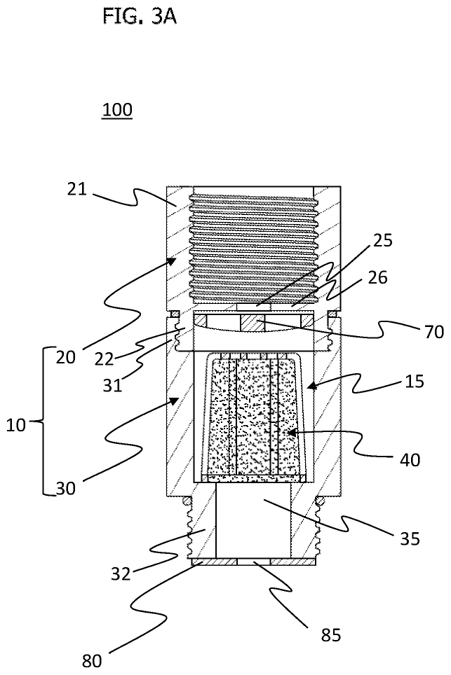

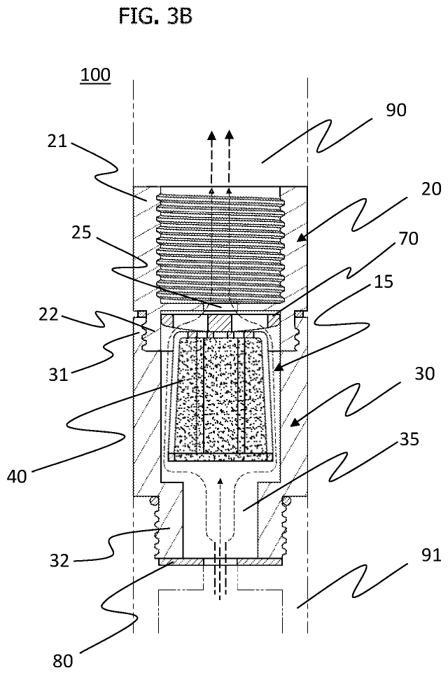

As shown in FIGS. 3A and 3B, the height of the filter chamber 15 is greater than the height of the filter frame 60. More precisely, the height of the filter chamber 15 less the thickness of the screen frame 70 is greater than the height of the filter frame 60. In addition, the diameter of the filter chamber 15 is slightly greater than the diameter of the bottom 62 of the filter frame 60, and the diameter of the bottom 62 of the filter frame 60 is greater than the diameter of the inlet 35 where the inlet 25 is cylindrical. Accordingly, as shown in FIG. 3B, when water enters the inlet 25, it pushes up the filter cartridge 40 so that the flat top 61 of the filter frame 60 becomes in contact with the outwardly curved bottom 72 of the screen frame 70. Water hits the bottom of the filter cartridge 40 and diverts to flow along the sides of the filter frame 60, exiting through the screen frame 70 and the outlet 25.

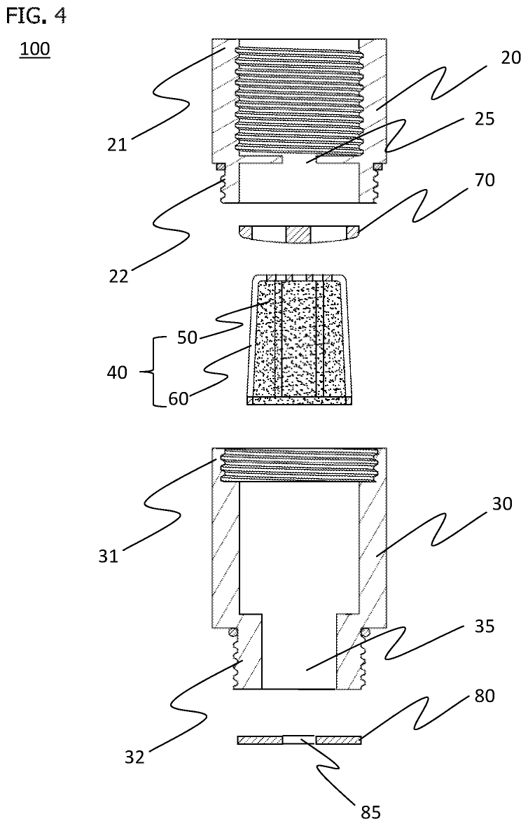

As shown in FIGS. 2, 3A, 3B, and 4, the shower filter assembly 100 further includes a rubber gasket 80, which is constructed to be placed right below the bottom of the lower case 30. The diameter of the filter chamber 15 is greater than the diameter of the inlet 35, the diameter of the outlet 25, and the diameter of a hole 85 of the gasket 80. The diameter of the inlet 35 and the diameter of the outlet 35 are smaller than the diameter of the water passage in the shower hose 91 or the diameter of the water passage in the shower head 90. Accordingly, the water pressure in the filter chamber 15 is smaller than that in the shower hose 91 or the shower head 90, and thus, the filter 50 can be more effectively, gradually, and better dissolved in the running water without being broken in large pieces. Furthermore, under this structure water swirls in the filter chamber 15 around the filter cartridge 40, more effectively dissolving the filter 50 from its side.

The filter 50 contains the aromatic oil and may further contain dextrin and guar gum. The aromatic oil is made of pure rose oil extract, indole, and water. More specifically, the aromatic oil is made by mixing about 1 weight percentage of pure rose oil extract, about 0.3 weight percentage of indole, and about 98.7 weight percentage of water at a room temperature of about 20-25° C. The mixture of rose oil and indole emits dog urine odors to attract dogs to bathing.

Dextrin is water soluble and porous and can retain aromatic oil in its pores so that aromatic oil can be effectively dispersed into the air from water, thus spreading dog urine smells to attract dogs to bathing. Guar gum is obtained from the seeds of the guar plant called Cyamopsis tetragonolobus and solidifies the mixture of aromatic oil, dextrin, guar gum, and water into a water-soluble gel-type solid which can be filled in the filter frame 60. The mixture may further include vitamin C which is an antioxidant for pets including dogs and helps reduce potentially harmful free radicals in pets' body and reduce inflammation and cognitive aging.

The filter 50, made of aromatic oil, dextrin, guar gum, vitamin C and water, is dissolved in the running water and comes out of the shower head 90 where the dog urine smells, emitted from aromatic oil, spread from the water into the air and dissipate. Thus, after the filter 50 is completely dissolved and dissipates, there is no more dog urine smells.

In the alternative embodiment, the shower filter assembly 100 for bathing a pet includes a housing 10 and a filter cartridge 40. The housing 10 includes an upper case 20 and a lower case 30, and the housing 10 is constructed to be installed between a shower head 90 and a water conduit 91. The filter cartridge 40 includes a filter 50 and a filter frame 60, and the filter frame 60 is constructed to retain the filter 50 therein.

Top portion 21 of the upper case 20 is threaded to be coupled to threads of the shower head 90, and bottom portion 32 of the lower case 30 is threaded to be coupled to threads of the water conduit 91. Bottom portion 22 of the upper case 20 and top portion 31 of the lower case 30 are respectively threaded to be coupled to each other to form a filter chamber 15 for receiving the filter cartridge 40 therein. In addition, the lower case 30 has an inlet 35 and the upper case 20 has an outlet 25 such that water flows from the water conduit 91 to the filter chamber 15 through the inlet 35 and flows out of the filter chamber 15 to the shower head 90 through the outlet 25. The filter 50 is made in gel-type solid and water-soluble, and side 63 of the filter frame 60 is made of a plurality of vertical ribs 66 to allow the water to dissolve the filter 50.

The upper case 20, the lower case 30, and the filter chamber 15 are cylindrical, and the filter frame 60 is cylindrical or truncated-cone-shaped. Top 61 of the filter frame 60 is made of radially extending ribs 64, which are respectively connected to the plurality of vertical ribs 66, and bottom 62 of the filter frame 60 is made of a circular rib 67, which is connected to the plurality of vertical ribs 66. Bottom 62 of the filter frame 60 may be covered by a removable sticker 68.

The shower filter assembly 100 further includes a screen frame 70, which is constructed to be retained right below the outlet 25 by a friction fit between the upper case 20 and the screen frame 70. The screen frame 70 is made by radially extending ribs 73 and a circumferential circular rib 74 such that the water passes through the screen frame 70 in between the radially extending ribs 73 of the screen frame 70 and then to the shower head 90 through the outlet 25. Top 71 of the screen frame 70 is flat whereas bottom 72 of the screen frame 70 is convex. Top 61 of the filter frame 60 is flat.

The height of the filter chamber 15 is greater than a height of the filter frame 60, and the diameter of the filter chamber 15 is slightly greater than the diameter of bottom 62 of the filter frame 60.

The shower filter assembly 100 further includes a gasket 80, which is constructed to be placed right below the bottom of the lower case 30. The diameter of the filter chamber 15 is greater than the diameter of the inlet 35; the diameter of the filter chamber 15 is greater than the diameter of the outlet 25; and the diameter of the filter chamber 15 is greater than the diameter of a hole 85 of the gasket 80.

Still in the alternative embodiment, a method for manufacturing a shower gel filter cartridge for attracting a dog to bathing, includes the steps of: mixing aromatic oil, dextrin, and guar gum for making a mixture; aging the mixture at about 10˜15° C. (first aging); adding water to the mixture and kneading the mixture for making the mixture doughy; and aging the mixture second time at about 10˜15° C. (second aging). After the step of mixing aromatic oil, dextrin, and guar gum, the mixture is made in the form of powder, and this step may further include adding vitamin C to make the mixture. Preferably, the step of first aging is for about 24 hours, and the step of second aging is for about 24 hours. In a preferred embodiment, the mixture is comprised of about 2-3 weight percentage of aromatic oil, about 30 weight percentage of dextrin, about 3-5 weight percentage of guar gum, about 60 weight percentage of vitamin C, and about 2-5 weight percentage of water, totaling 100%. The method may further include the step of filling the mixture into a filter frame 60 to make to the filter cartridge 40.

The aromatic oil is made of pure rose oil extract, indole, and water. More specifically, the aromatic oil is made by mixing about 1 weight percentage of pure rose oil extract, about 0.3 weight percentage of indole, and about 98.7 weight percentage of water at a room temperature of about 20-25° C. The mixture of rose oil and indole emits dog urine odors to attract dogs to bathing.

While the invention has been shown and described with reference to different embodiments thereof, it will be appreciated by those skilled in the art that variations in form, detail, compositions and operation may be made without departing from the spirit and scope of the invention as defined by accompanying claims.

What is claimed is:

1. A shower filter assembly for attracting a dog to bathing, comprising:
a housing, which includes an upper case and a lower case, wherein the housing is constructed to be installed between a shower head and a water conduit; and
a filter cartridge, which includes a filter and a filter frame, wherein the filter frame is constructed to retain the filter therein,
wherein top portion of the upper case is threaded to be coupled to threads of the shower head, and bottom portion of the lower case is threaded to be coupled to threads of the water conduit,
wherein bottom portion of the upper case and top portion of the lower case are respectively threaded to be coupled to each other to form a filter chamber for receiving the filter cartridge therein,
wherein the lower case has an inlet and the upper case has an outlet such that water flows from the water conduit to the filter chamber through the inlet and flows out of the filter chamber to the shower head through the outlet,
wherein the filter is made in gel-type solid and water-soluble and contains aromatic oil which emits dog urine odors,
wherein the filter frame is constructed to allow the filter to be dissolved in the water.

2. The shower filter assembly of claim 1, wherein the upper case, the lower case, and the filter chamber are cylindrical, and wherein the filter frame is cylindrical or truncated-cone-shaped.

3. The shower filter assembly of claim 2, wherein side of the filter frame is made of a plurality of vertical ribs.

4. The shower filter assembly of claim 3, wherein top of the filter frame is made of radially extending ribs, which are respectively connected to the plurality of vertical ribs.

5. The shower filter assembly of claim 4, wherein bottom of the filter frame is made of a circular rib, which is connected to the plurality of vertical ribs,
wherein the top of the filter frame further comprises a circular rib which are connected to the radially extending ribs, and
wherein a diameter of the circular rib of the top of the filter frame is smaller than a length of the radially extending rib and also smaller than a diameter of the circular rib of the bottom of the filter frame.

6. The shower filter assembly of claim 5, wherein the bottom of the filter frame is covered by a removable sticker
wherein the filter is constructed to be substantially completely dissolved in the running water in about 3-5 minutes when the sticker is removed and the filter is placed in the filter chamber, and
wherein the filter is constructed to be substantially completely dissolved in the running water in about 10-20 minutes when the sticker is not removed and the filter is placed in the filter chamber.

7. The shower filter assembly of claim 2, further including a screen frame, which is constructed to be retained right below the outlet by a friction fit between the upper case and the screen frame, and wherein the screen frame is made by radially extending ribs and a circumferential circular rib such that the water passes through the screen frame in between the radially extending ribs of the screen frame and then to the shower head through the outlet.

8. The shower filter assembly of claim 7, wherein top of the screen frame is flat and bottom of the screen frame is convex, and wherein top of the filter frame is flat.

9. The shower filter assembly of claim 7, wherein a height of the filter chamber is greater than a height of the filter frame,
wherein a diameter of the filter chamber is slightly greater than a diameter of bottom of the filter frame,
wherein the inlet is cylindrical, and
wherein the diameter of the bottom of the filter frame is greater than a diameter of the inlet.
(such that when the water flows, the water pushes up the filter frame against the screen frame so that water hits the bottom of the filter frame and diverts to flow along the side of the filter frame)

10. The shower filter assembly of claim 7, further comprising a gasket, which is constructed to be placed right below bottom of the lower case,
wherein a diameter of the filter chamber is greater than a diameter of the inlet,
wherein the diameter of the filter chamber is greater than a diameter of the outlet, and
wherein the diameter of the filter chamber is greater than a diameter of a hole of the gasket.

11. The shower filter assembly of claim 1, wherein the aromatic oil is made of rose oil extract, indole and water.

12. The shower filter assembly of claim 1, wherein the filter further contains dextrin, guar gum, and vitamin C.

13. A shower filter assembly for being used to bathe a pet, comprising:
a housing, which includes an upper case and a lower case, wherein the housing is constructed to be installed between a shower head and a water conduit; and
a filter cartridge, which includes a filter and a filter frame, wherein the filter frame is constructed to retain the filter therein,
wherein top portion of the upper case is threaded to be coupled to threads of the shower head, and bottom portion of the lower case is threaded to be coupled to threads of the water conduit,
wherein bottom portion of the upper case and top portion of the lower case are respectively threaded to be coupled to each other to form a filter chamber for receiving the filter cartridge therein,
wherein the lower case has an inlet and the upper case has an outlet such that water flows from the water conduit to the filter chamber through the inlet and flows out of the filter chamber to the shower head through the outlet,
wherein the filter is made in gel-type solid and water-soluble,
wherein side of the filter frame is made of a plurality of vertical ribs to allow the water to dissolve the filter.

14. The shower filter assembly of claim 13, wherein the upper case, the lower case, and the filter chamber are cylindrical,
wherein the filter frame is cylindrical or truncated-cone-shaped,
wherein top of the filter frame is made of radially extending ribs, which are respectively connected to the plurality of vertical ribs,
wherein bottom of the filter frame is made of a circular rib, which is connected to the plurality of vertical ribs, and
wherein bottom of the filter frame is covered by a removable sticker.

15. The shower filter assembly of claim 14, further including a screen frame, which is constructed to be retained right below the outlet by a friction fit between the upper case and the screen frame, and wherein the screen frame is made by radially extending ribs and a circumferential circular rib such that the water passes through the screen frame in between the radially extending ribs of the screen frame and then to the shower head through the outlet,
wherein top of the screen frame is flat and bottom of the screen frame is convex, and wherein top of the filter frame is flat,
wherein a height of the filter chamber is greater than a height of the filter frame, and
wherein a diameter of the filter chamber is slightly greater than a diameter of bottom of the filter frame.

16. The shower filter assembly of claim 15, further comprising a gasket, which is constructed to be placed right below the bottom of the lower case,
wherein a diameter of the filter chamber is greater than a diameter of the inlet,
wherein the diameter of the filter chamber is greater than a diameter of the outlet, and
wherein the diameter of the filter chamber is greater than a diameter of a hole of the gasket.

17. A method for manufacturing a filter cartridge for attracting a dog to bathing, comprising the steps of:
mixing aromatic oil, dextrin, guar gum, and vitamin C for making a mixture;
aging the mixture at about 10˜15° C.;
adding water to the mixture and kneading the mixture for making the mixture doughy; and
aging the mixture second time at about 10˜15° C.

18. The method of claim 17, wherein the step of first aging is for about 24 hours, and the step of second aging is for about 24 hours.

19. The method of claim 17, wherein wherein the aromatic oil is made of rose oil extract, indole and water.

20. The method of claim 17, wherein aromatic oil comprises about 2-3 weight percentage of the mixture which includes water, dextrin comprises about 30 weight percentage of the mixture which includes water, guar gum comprises about 3-5 weight percentage of the mixture which includes water, and vitamin C comprises about 60 weight percentage of the mixture which includes water.
